(19) United States
(12) Patent Application Publication
(10) Pub. No.: US 2026/0010005 A1
(43) Pub. Date: Jan. 8, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: MIZUKI MATSUBARA, Tokyo (JP)

(21) Appl. No.: 19/252,280

(22) Filed: Jun. 27, 2025

(30) Foreign Application Priority Data
Jul. 8, 2024 (JP) 2024-109919

(51) Int. Cl. G02B 27/01; G06F 3/0484; G06T 19/00; G06V 10/44

(52) U.S. Cl. CPC G02B 27/017; G06F 3/0484; G06T 19/006; G06V 10/44

(57) ABSTRACT

In an XR technique using an HMD, the present disclosure is directed to suppressing the occurrence of a situation not intended by a wearer. To achieve this, an information processing apparatus controlling a non-head-mounted first display device and a head-mounted second display device includes an obtaining unit configured to obtain stop information on a display on a virtual screen in the second display device and a processing unit configured to determine, in a case where the obtaining unit obtains the stop information, a display content on a real screen in the first display device in a case where the display on the virtual screen in the second display device is stopped.

### BACKGROUND

### Field of the Technology

The present disclosure relates to a video image technique using an HMD.

### Description of the Related Art

In recent years, a technique that allows a wearer to enjoy realistic video images by using a head-mounted image display device (Head Mounted Display; hereinafter referred to as “HMD”) has become widespread. For example, in MR (mixed reality), which is a type of XR (cross reality) technique that combines virtual space and real space, an HMD wearer can perform office work such as document creation while viewing an image in which a virtual display is superimposed on an image of the real space (a first use case; see FIG. 1A). Alternatively, before purchasing furniture or the like, a mixed reality image in which CG of the furniture or the like is superimposed on an image of an installation destination can be used to grasp an image at the time of installation, for example, whether the furniture or the like matches with the installation destination (a second use case; see FIG. 1B). Regarding the first use case, for example, Japanese Patent Laid-Open No. 2012-233963 discloses a technique for expanding a screen of a liquid crystal monitor or the like on a desk with an HMD and displaying confidential information on a screen of the HMD to prevent others from viewing the confidential information. Regarding the second use case, Japanese Patent Laid-Open No. 2007-018173 discloses a technique for reproducing the reflection of virtual lighting by holding environment mapping for a virtual object expressed by CG and drawing the virtual lighting on an environment map according to the position and orientation of the virtual lighting and the like.

### SUMMARY

An information processing apparatus according to the present disclosure is an information processing apparatus controlling a non-head-mounted first display device and a head-mounted second display device, the information processing apparatus having: an obtaining unit configured to obtain stop information on a display on a virtual screen in the second display device; and a processing unit configured to determine, in a case where the obtaining unit obtains the stop information, a display content on a real screen in the first display device in a case where the display on the virtual screen in the second display device is stopped.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are diagrams for explaining the background art;

FIG. 2A is a diagram showing a configuration example of a display system and FIG. 2B is a diagram showing a hardware configuration example of an HMD;

FIG. 3A is a diagram showing an example of a hardware configuration of an information processing apparatus and FIG. 3B is a diagram showing an example of a software configuration of the information processing apparatus according to a first embodiment;

FIGS. 4A and 4B are diagrams showing examples of editing of display contents;

FIG. 5 is a flowchart showing an operation flow in the information processing apparatus according to the first embodiment;

FIG. 6 is a flowchart showing details of a display determination process according to the first embodiment;

FIG. 7 is a diagram showing an example of window information in a table format;

FIG. 8 is a flowchart showing details of the display determination process according to a first modification example of the first embodiment;

FIG. 9 is a diagram showing an example of the window information in the table format;

FIG. 10 is a flowchart showing details of the display determination process according to a second modification example of the first embodiment;

FIG. 11 is a diagram showing an example of a process for making a form invisible;

FIGS. 12A and 12B are diagrams for explaining specific examples of a situation where optical consistency in a mixed reality image is reduced;

FIG. 13A is a diagram showing an example of a software configuration of the information processing apparatus according to a second embodiment, and FIG. 13B is a diagram showing an example of the software configuration of the information processing apparatus according to a first modification example of the second embodiment;

FIG. 14A is a diagram for explaining a real image, and FIGS. 14B and 14C are diagrams for explaining an environment map;

FIG. 15 is a flowchart showing an operation flow in the information processing apparatus according to the second embodiment;

FIG. 16A is a diagram showing an example of an object detection result, and FIG. 16B is a diagram showing an example of a detection result table;

FIG. 17 is a flowchart showing details of a removal region determination process according to the second embodiment;

FIG. 18A is a diagram showing an example of an object detection feature region image, FIG. 18B is a diagram showing an example of an image feature region image, and FIG. 18C is a diagram showing an example of a three-dimensional feature region image;

FIG. 19 is a diagram for explaining a situation example according to the first modification example of the second embodiment;

FIG. 20 is a flowchart showing the operation flow of the information processing apparatus according to the first modification example of the second embodiment;

FIG. 21 is a diagram for explaining a situation example according to a second modification example of the second embodiment;

FIG. 22A is a diagram showing an example of the software configuration of the information processing apparatus according to the second modification example of the second embodiment, and FIG. 22B is a diagram showing an example of the software configuration of the information processing apparatus according to a third modification example of the second embodiment;

FIG. 23 is a flowchart showing the operation flow of the information processing apparatus according to the second modification example of the second embodiment;

FIG. 24 is a flowchart showing details of the removal region determination process according to the second modification example of the second embodiment; and

FIG. 25 is a flowchart showing the operation flow of the information processing apparatus according to the third modification example of the second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

The inventor of the present application identified the following issues in the prior art through his investigation. In the first use case described at the beginning, there is a possibility that in a case where the HMD is disconnected, a screen viewed on the HMD is aggregated on a liquid crystal monitor or the like in real space and can be browsed by others, so that confidential information or the like may be seen by others. The second use case has a problem in that in a case where an obstructive object in the real space is erased from an image through a diminishment process, the obstructive object (diminishment object) in an environment map affects CG and optical consistency in a mixed reality image is reduced.

### First Embodiment

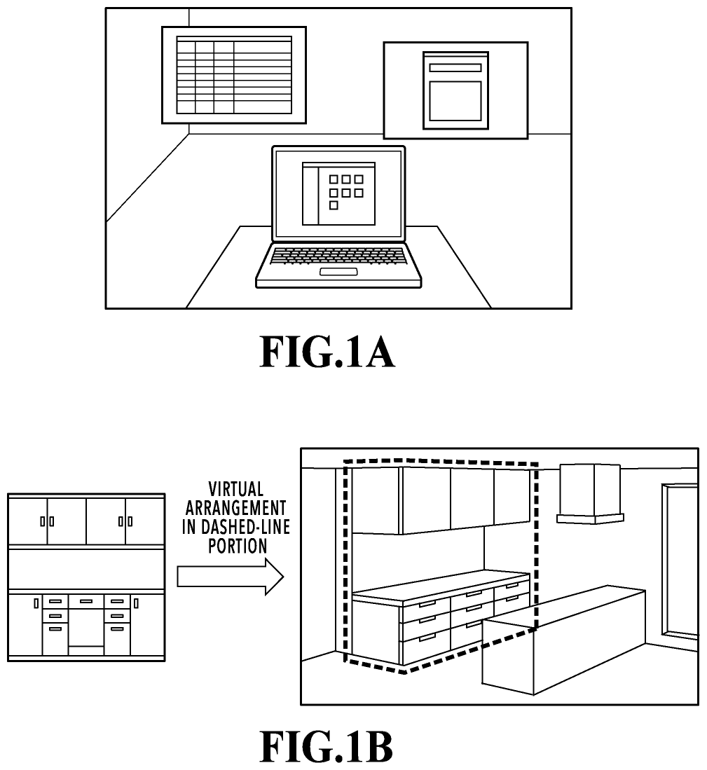

In the present embodiment, there will be described an aspect in which in a use case in which a screen of a display device installed on a desk is expanded with an HMD (see FIG. 1A above), in a case where a display on the HMD is stopped, contents displayed on the HMD are prevented from being displayed on the screen of the display device on the desk.

### System Configuration

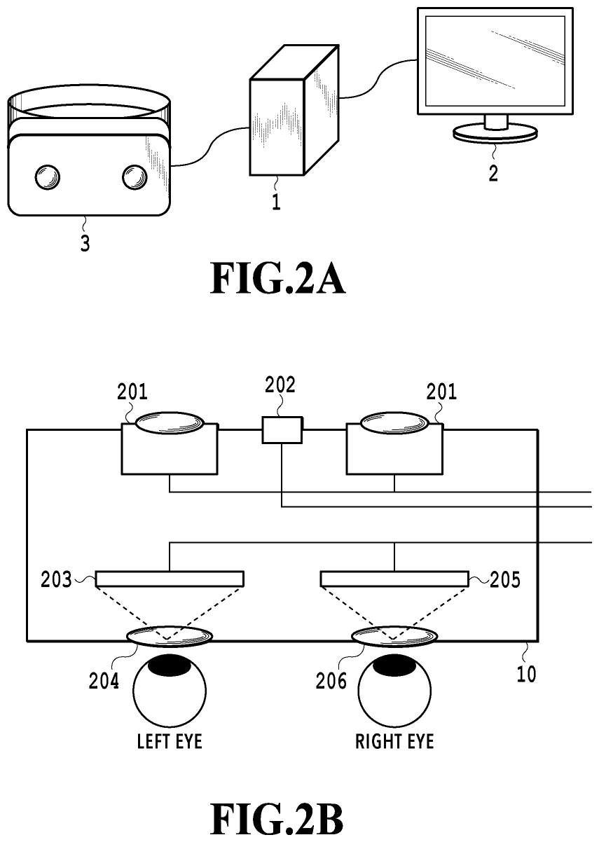

FIG. 2A is a diagram showing a configuration example of a display system. The display system shown in FIG. 2A includes an information processing apparatus 1, a first display device 2, and a second display device 3. The first display device 2 is a display device installed on a desk or table in a state where the first display device 2 can be browsed by others, and corresponds to a liquid crystal monitor, a mobile terminal, a projector, a 3D compatible monitor, or the like. Hereinafter, the first display device 2 will be referred to as “monitor” for convenience of explanation. The second display device 3 is a video see-through head mounted display (HMD) that is worn on a person's head and used. In the present embodiment, the HMD 3 captures the monitor 2 through a built-in RGB camera and displays a mixed reality image in which a display region is expanded by superimposing a virtual screen (virtual display) on a captured video image. Incidentally, the HMD 3 may be an optical see-through one. Further, instead of the see—through one, the HMD 3 may be an HMD for VR that displays a virtual reality image expressed only by CG. In the present embodiment, the information processing apparatus 1 is described as a system configuration independent of the HMD 3, but an integral HMD system including the information processing apparatus 1 inside the HMD 3 may be used. Further, an integral PC including the information processing apparatus 1 inside the monitor 2 may also be used.

### Hardware Configuration of HMD

FIG. 2B is a diagram showing an example of the hardware configuration of the HMD 3. The HMD 3 includes a plurality of RGB cameras 201 and an inertial measurement unit (IMU) (not shown) to realize position tracking by an inside-out method. The IMU is a device that detects three-dimensional inertial motion (translational motion and rotational motion in three orthogonal axial directions) and includes a gyroscope sensor that captures the rotational motion and an acceleration sensor that captures the translational motion. Further, the HMD 3 includes a distance sensor 202 such as Light Detection And Ranging (LiDAR) for obtaining depth information. The HMD 3 also includes a left eye display 203 and a right eye display 205 that are formed of a liquid crystal panel, an organic EL panel, or the like for displaying an image for a left eye and an image for a right eye, respectively. Further, a left eye eyepiece lens 204 and a right eye eyepiece lens 206 are arranged in front of the displays 203 and 205, respectively, and the wearer observes the enlarged virtual images of images displayed for the left eye and the right eye, respectively, through the lenses 204 and 206, respectively. The HMD 3 generates an image for a left eye and an image for a right eye based on a mixed reality image provided by the information processing apparatus 1 and displays the image for the left eye on the left eye display 203 and the image for the right eye on the right eye display 206. At this time, it is possible to give the wearer a video image perception with a sense of depth by providing an appropriate parallax between the image for the left eye and the image for the right eye. Incidentally, the HMD 3 includes components other than those described above, but since the components are not the main focus of the present disclosure, a description thereof will be omitted.

### Hardware Configuration of Information Processing Apparatus

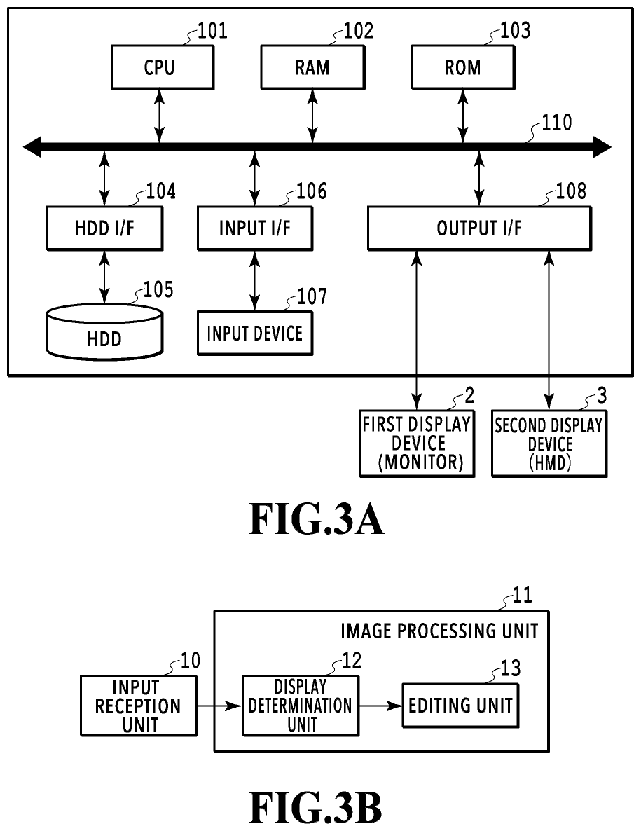

An example of the hardware configuration of the information processing apparatus 1 will be described with reference to FIG. 3A. In FIG. 3A, the CPU 101 executes a program stored in a ROM 103 and a hard disk drive (HDD) 105 using a RAM 102 as work memory and controls the operation of each block described later via a system bus 110. An HDD interface (hereinafter, interface will be referred to as “I/F”) 104 connects a secondary storage device such as an HDD 105 and an optical disk drive. The HDD I/F 104 is, for example, an I/F such as a serial ATA (SATA). The CPU 101 can read data from the HDD 105 and write data to the HDD 105 via the HDD I/F 104. Further, the CPU 101 can expand data stored in the HDD 105 into the RAM 102, and conversely, can save data expanded into the RAM 102 to the HDD 105. The CPU 101 can execute the data expanded into the RAM 102 as a program. An input I/F 106 connects an input device 107 such as a keyboard, a mouse, a digital camera, a scanner, and an acceleration sensor. The input I/F 106 is, for example, a serial bus I/F such as USB or IEEE1394. The CPU 101 can read data from the input device 107 via the input I/F 106. An output I/F 108 connects the monitor 2 and the HMD 3. The output I/F 108 is, for example, a video image output I/F such as DVI or HDMI (registered trademark). The CPU 101 can send data to the monitor 2 and the HMD 3 via the output I/F 108 to display a predetermined video image. The information processing apparatus 1 includes components other than those described above, but since the components are not the main focus of the present disclosure, a description thereof will be omitted.

Each of the information processing apparatus 1 and the HMD 3 may be a system configuration having the hardware configuration shown in FIG. 3A. In this case, the HMD 3 and the information processing apparatus 1 may exchange information on an application window (hereinafter, simply referred to as “window”) or the like through the input I/Fs 106 and output I/Fs 108 of the HMD 3 and the information processing apparatus 1. This enables use of, for example, both the input function of the HMD 3 and input to the information processing apparatus 1. In a case where the HMD 3 has an input function using hand gesture recognition, both hand gesture input with the HMD 3 and input by a mouse and keyboard operation with the information processing apparatus 1 are possible.

### Software Configuration of Information Processing Apparatus 1

FIG. 3B is a block diagram showing an example of the software configuration (logical configuration) of the information processing apparatus 1 according to the present embodiment. In FIG. 3B, the information processing apparatus 1 includes an input reception unit 10 and an image processing unit 11, and the image processing unit 11 includes a display determination unit 12 and an editing unit 13.

The input reception unit 10 receives various user inputs in addition to data on an image (real image) obtained by capturing real space with the HMD 3. In the present embodiment, as one of the user inputs, stop information on a display on the HMD 3 is received. The stop information includes, for example, the user's instruction to stop the display on the HMD 3 from a user via a mouse, keyboard, or hand gesture, as well as a detection signal for removal of the HMD 3 body from the head or disconnection from the HMD 3 (for example, cable disconnection). The stop information received by the input reception unit 10 is output to the display determination unit 12.

The display determination unit 12 determines what to display on the monitor 2 in a case where the display on the HMD 3 is stopped. A determination result is output to the editing unit 13.

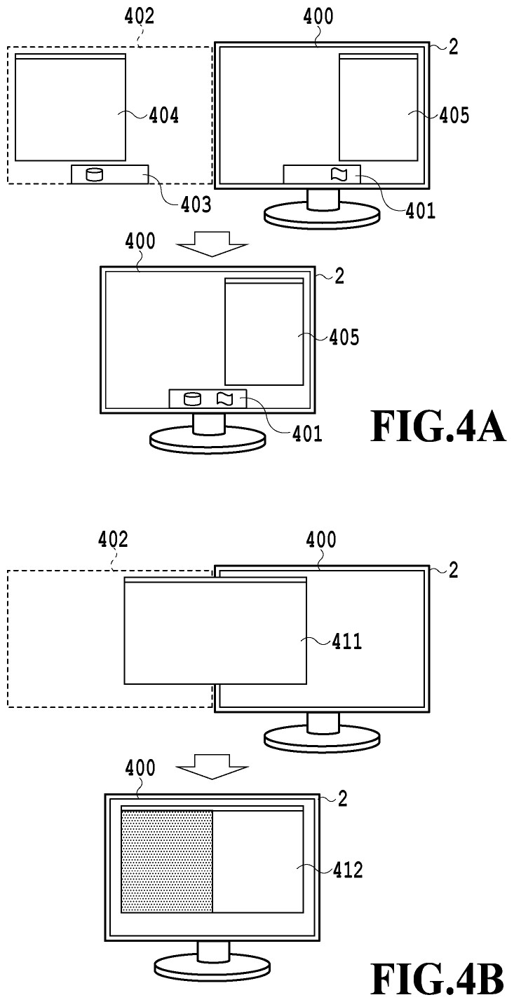

The editing unit 13 edits contents displayed on the monitor 2 based on the determination result made by the display determination unit 12. FIGS. 4A and 4B are diagrams showing an example of an editing process. FIG. 4A shows a case where a window displayed on the HMD 3 is minimized and displayed on the screen of the monitor 2. The upper section of FIG. 4A shows a state before the display on the HMD 3 is stopped, where a window 405 is displayed on a real screen 400 of the monitor 2 and a window 404 is displayed on the virtual screen 402. Further, a real icon portion 401 in the real screen 400 displays an icon for an application corresponding to the window 405 affiliated with the monitor 2. Similarly, a virtual icon portion 403 in the virtual screen 402 displays an icon for an application corresponding to the window 404 affiliated with the HMD 3. A user can click these icons, thereby hiding or redisplaying the windows corresponding to the icons. The lower section of FIG. 4A shows a state after the display on the HMD 3 is stopped, where the virtual screen 402 disappears and the window 405 is displayed on the real screen 400 of the monitor 2. An icon corresponding to the window 404 displayed on the virtual screen 402 is also added to the real icon portion 401. FIG. 4B shows an example in which a region corresponding to a window displayed on the HMD 3 out of a region for a window displayed on the monitor 2 is filled in. In the upper section of FIG. 4B, the display region for the window 411 is expanded by the HMD 3. That is, the portion of the window 411 that overlaps the monitor 2 is displayed on the monitor 2, and the portion of the window 411 that extends beyond the monitor 2 to the left is superimposed on a real image with the HMD 3 and displayed on the virtual screen 402. The lower section of FIG. 4B shows a state after the display on the HMD 3 is stopped, where the virtual screen 402 disappears and a region corresponding to the region displayed on the virtual screen 402 is filled in on the window 412 on the real screen 400 of the monitor 2. In performing such a filling edit, it is only required to refer to window information and fill a region displayed on the HMD 3 with, for example, gray based on information on the coordinates and size of the region. Further, although not illustrated herein, an edit may be performed such that the window displayed on the HMD 3 is arranged behind the window 405 displayed on the monitor 2 (a front-to-back relationship is reversed).

### Operation Flow of Information Processing Apparatus

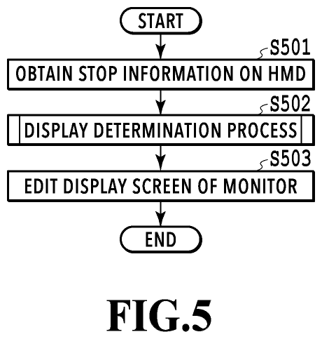

FIG. 5 is a flowchart showing an operation flow in the information processing apparatus 1 according to the present embodiment. In the following description, each symbol “S” means a step.

In S501, the input reception unit 10 obtains stop information on a display on the HMD 3. As described above, this stop information is obtained, for example, based on an operation signal in a case where a user presses a display stop button (not shown) provided on the HMD 3, or by a user inputting a display stop instruction to the information processing apparatus 1 through the input device 107. Incidentally, the display may be stopped upon detection of disconnection of the output I/F 108 to the HMD 3. The display may also be stopped upon detection of interruption of power supply to the HMD 3.

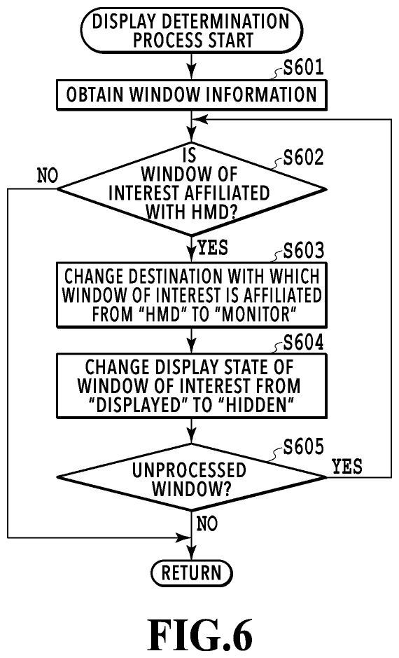

In S502, the display determination unit 12 determines what to display on the monitor 2 in response to the stop of the display on the HMD 3. FIG. 6 is a flowchart showing the details of a display determination process according to the present step. Here, a description will be given with reference to the flowchart in FIG. 6.

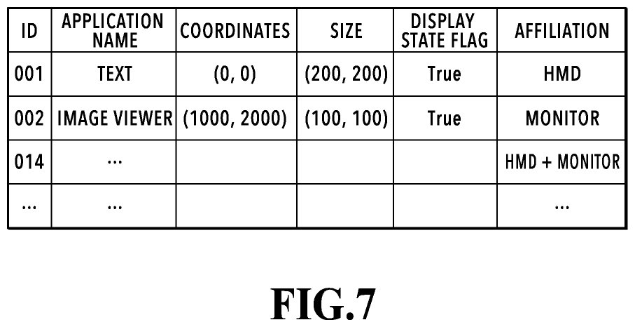

In S601, information on windows corresponding to all running applications (hereinafter, referred to as “window information”) is obtained. FIG. 7 shows an example of window information in a table format, with one row corresponding to one window. In an “ID” column, a unique ID that uniquely identifies a window is entered. In an “Application Name” column, an application name corresponding to the window is entered. In a “Coordinates” column, x and y coordinate values of an upper left end of the window are entered. Here, it is assumed that the origin of coordinates is the coordinates of the upper left end of the monitor 2. In a “Size” column, values indicating the width and height (width, height) of the window are entered. In a “Display Status Flag” column, a flag value indicating whether the window is being displayed or hidden (minimized) is entered. In the present embodiment, “True” is a value indicating a displayed state, and “False” is a value indicating a hidden state. In an “Affiliation” column, a value specifying whether the affiliation of the window is the monitor 2, the HMD 3, or both is entered. In the present embodiment, for convenience, character strings “Monitor” and “HMD” are entered. However, numerical values such as “0=monitor+HMD,” “1=monitor,” and “2=HMD” may also be entered. Incidentally, each item (column) constituting the table is an example, and for example, “Start Point and End Point” may be used instead of “Size.” Further, both upper left ends of the HMD 3 and the monitor 2 may be the origins. That is, the window 404 affiliated with the HMD 3 may have the upper left end of the HMD 3 as the origin, and the window 405 affiliated with the monitor 2 may have the upper left end of the monitor 2 as the origin. Further, the origin does not have to be the upper left end but may be the center or the lower right end of a screen. The table may also have an item such as a front-to-back relationship between windows. The front-to-back relationship is a relationship that determines which window to draw on the display device in a case where a plurality of windows are in a positional relationship in which the windows are drawn in the same region. Further, the data format of window information does not have to be the table format as described above and has only to be a data format that allows the above information on the windows corresponding to all running applications to be grasped.

In S602, a window of interest is determined from among the windows included in the window information obtained in S601, and it is determined whether the affiliation of the window of interest is the HMD. In the present embodiment, this determination is made using a value in the “Affiliation” column in the table in FIG. 7 described above. In a case where the window of interest is affiliated with the HMD 3, S603 is executed next. On the other hand, in a case where the window of interest is not affiliated with the HMD, this flow ends.

In S603, the affiliation of the window of interest, which is indicated by the window information obtained in S601 is changed from the HMD to the monitor. In the present embodiment, the value in the “Affiliation” column in the table in FIG. 7 described above is changed from “HMD” to “Monitor.”

In S604, the display state of the window of interest indicated by the window information obtained in S601 is changed from “Displayed” to “Hidden.” In the present embodiment, the value in the “Display State Flag” column in the table in FIG. 7 is changed from “True” to “False.”

In S605, it is determined whether there is an unprocessed window. In a case where all windows in the window information have been processed, the present flow ends. On the other hand, in a case where there is an unprocessed window, the process returns to S602 and continues. The above are the contents of the display determination process according to the present embodiment. The description will return to the flow in FIG. 5.

In S503, the editing unit 13 edits the display screen of the monitor 2 based on the window information after S502 so that the window of the HMD 3 whose display state has been changed from “Displayed” to “Hidden” is not displayed on the monitor 2. In the present embodiment, in a case where there is a window that is not minimized among the windows whose value in the “Display State” column in the table in FIG. 7 is “False,” the window is to be minimized (windows that are originally minimized remain as they are).

The above are the contents of the operation flow in the information processing apparatus 1 in a case where the display on the HMD 3 is stopped. In the present embodiment, an example of using a two-dimensional window as the display screen is described, but a three-dimensional window may be used. In this case, the “Coordinates” included in the window information need to be three-axis coordinates (x, y, z) rather than two-axis coordinates (x, y). Further, the “Size” is not (width, height) but includes information necessary for three-dimensional displays, such as the orientation and magnification of the window. In the present embodiment, a case where the number of monitors 2 is one has been described, but there may be two or more monitors 2. In this case, in each “Affiliation” item included in the window information, a character string or the like that uniquely indicates a display device may be described. In the present embodiment, one window corresponds to one application, but one application may correspond to a plurality of windows. Further, one application may display a window on each of the monitor 2 and the HMD 3. In that case, an icon corresponding to the one application may be displayed in each of the real icon portion 401 and the virtual icon portion 403.

### First Modification Example

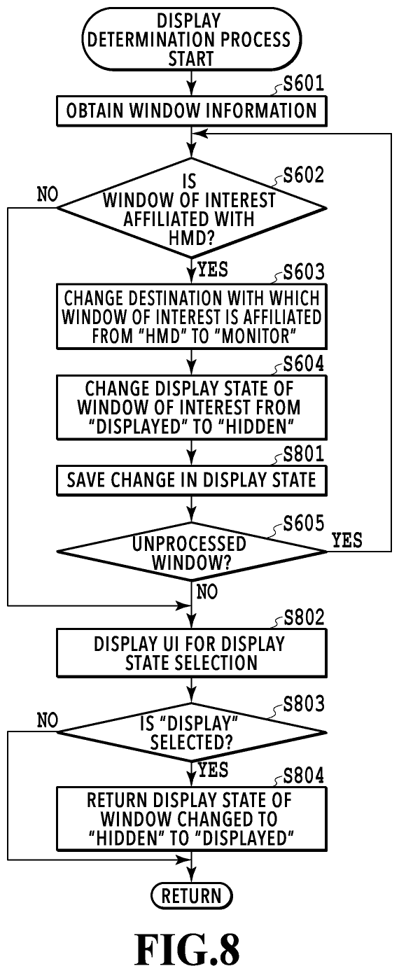

In the above embodiment, the contents of the display screen of the HMD 3 are edited based on the display stop information so as not to be seen by others, but there may be cases where it is acceptable to display the contents on the monitor 2 as they are. In the present modification example, an aspect will be described in which a user is free to decide whether to display the contents of the display screen of the HMD 3 on the monitor 2. FIG. 8 is a flowchart showing the details of the display determination process according to the present modification example. The same step number is given to a step having the same contents as in the flowchart in FIG. 6 described above and a description of the step will be omitted. The display determination process according to the present modification example will be described below with reference to the flowchart in FIG. 8.

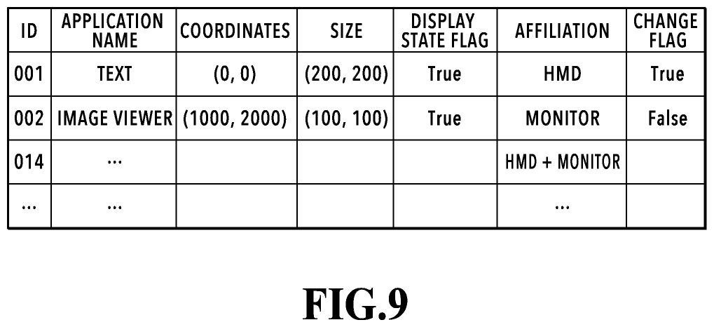

In S801, information indicating that the display state of the window of interest displayed on the HMD 3 has been changed from “Displayed” to “Hidden” is saved. For example, a “Change Flag” column is newly provided in the table as the window information described above as shown in FIG. 9, and a flag value indicating whether “Displayed” has been changed to “Hidden” is held. This flag value is initialized to “False” indicating that no change is made, and in a case where “Displayed” is changed to “Hidden,” “True” is substituted, thereby saving the fact that the window of interest is made hidden. This makes it possible to distinguish the window from a window that has been originally hidden on the monitor 2.

In S802, a user interface (UI) (not shown) for a user to select whether to display the window of interest displayed on the HMD 3 also on the monitor 2 is displayed. This UI, for example, prompts the user to press a “Yes” button in a case where the contents displayed on the HMD 3 are to be displayed also on the monitor 2 and a “No” button in a case where the contents are not to be displayed, and is displayed, for example, in a pop-up manner on the real screen of the monitor 2. Incidentally, the above-mentioned UI is an example and may require input of a password instead of pressing the “Yes” button, for example.

In S803, in a case where the user selects, via the UI displayed in S902, to display the window of interest displayed on the HMD 3 also on the monitor 2, S804 will be executed next. On the other hand, in a case where the user does not select to display the window of interest displayed on the HMD 3 also on the monitor 2, the present flow ends.

In S804, in order to display a window for user selection also on the monitor 2, the display state of the window is changed from “Hidden (False)” to “Displayed (True)” in the window information. At this time, the change flag can also be initialized, thereby preventing malfunctions in a case where the same window is redisplayed on the HMD 3.

The above are the contents of the display determination process according to the present modification example. Incidentally, a window that is affiliated with the HMD 3 but is hidden is not targeted to be redisplayed since the value of the change flag is maintained as “False.” Further, an example in which a UI for confirming a user's intention is displayed has been shown, but the user may set whether to perform redisplaying in advance, save the setting in the RAM 102 or the like, and determine whether to execute S804 by reading the contents of the setting instead of S802 and S803. Further, in the present modification example, the example in which redisplaying is selected after once hidden is selected has been shown, but it is not necessary to select hidden once. For example, the above-mentioned UI may be displayed immediately after stopping the display of a window on the HMD 3, and whether to display the window on the monitor 2 may be controlled according to a user selection. Further, instead of displaying the UI as a window on the monitor 2, a hardware button (not shown) may be installed, and pressing of the button may be detected as a user selection.

### Second Modification Example

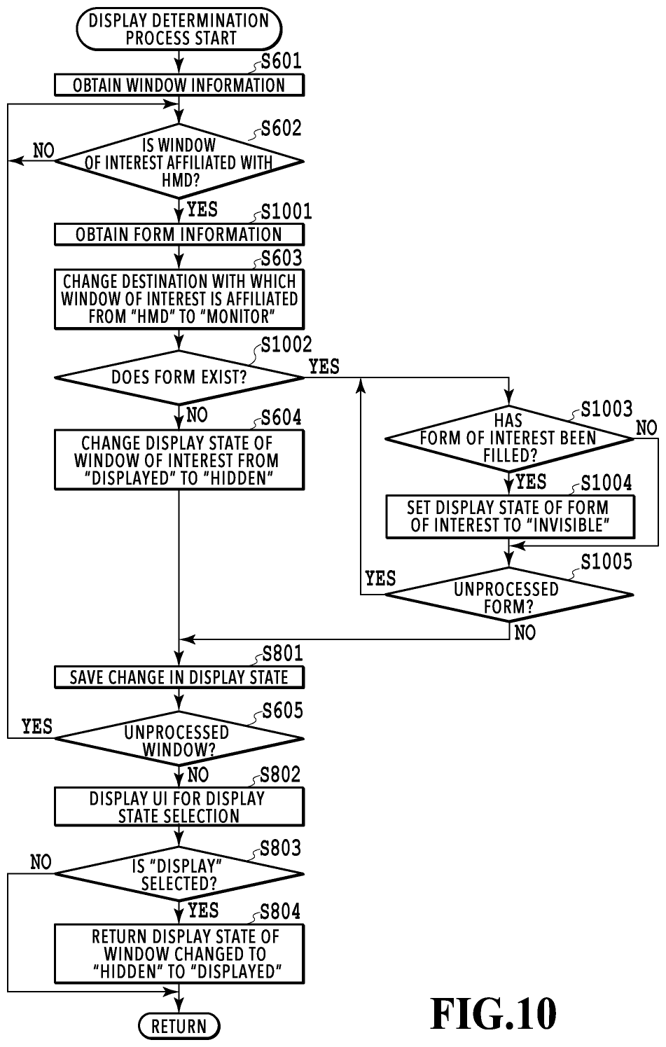

In a case where the window displayed on the HMD 3 is a form for inputting personal information or the like, in a case where the form is also displayed on the monitor 2 according to a user selection, a character string or the like that has already been entered in the form by the user may be made invisible. FIG. 10 is a flowchart showing the details of the display determination process according to the present modification example. The same step number is given to a step having the same contents as in the flowchart in FIG. 8 described above, and a description thereof will be omitted. The display determination process according to the present modification example will be described below with reference to the flowchart in FIG. 10.

In S1001, form information is obtained. For example, in the case of a web page in an HTML format, the form information is obtained by searching for an HTML description corresponding to a form and parsing (syntax-analyzing) the description found. This form information includes information on whether a character string or the like has been entered and may further include a form identifier, a form position, a form type, and the like. At this time, the display screen of the HMD 3 may be captured, and a known image recognition technique may be applied to a captured image to estimate the position of the form and whether a character string or the like has been entered. Incidentally, it is also possible to filter out the types of forms that can be seen by others, and not to obtain form information on the forms.

In S1002, a step to be executed next is determined depending on whether there is a form in the window of interest. In a case where the window of interest includes a form, S1003 is executed next, and if not, S604 is executed next. Each of the subsequent steps S1003 to S1005 is executed for each form in the window of interest. Incidentally, a description of S1004 in a case where no form is included will be omitted.

In S1003, it is determined whether a character or the like has been entered into a form of interest among one or more forms included in the window of interest. In a case where a character or the like has been entered, S1004 is executed next, and in a case where a character or the like has not been entered, S1004 is skipped and S1005 is executed.

In S1004, the display state of the form of interest is set to invisible. Specifically, for example, a form list is prepared for each window, and settings for the form of interest are made by associating a form identifier with flag information (form flag) indicating whether to make the form of interest invisible. For example, for this flag value, “True” means visible and “False” means invisible, and the initial value is set to “True.” As a result, only a form that has been filled in is set to invisible. At this time, for example, the form may be held in a tuple format, which is a data type in which a plurality of elements are arranged in fixed order, that is, (a form identifier, a form flag value).

In S1005, a step to be executed next is determined depending on whether there is an unprocessed form in the window of interest. If all forms have been processed, S901 is executed next. On the other hand, if there is an unprocessed form, the process returns to S1003 and continues. Since S801 and the subsequent steps are the same as in the first modification example, a description thereof will be omitted. The above are the contents of the display determination process according to the present modification example.

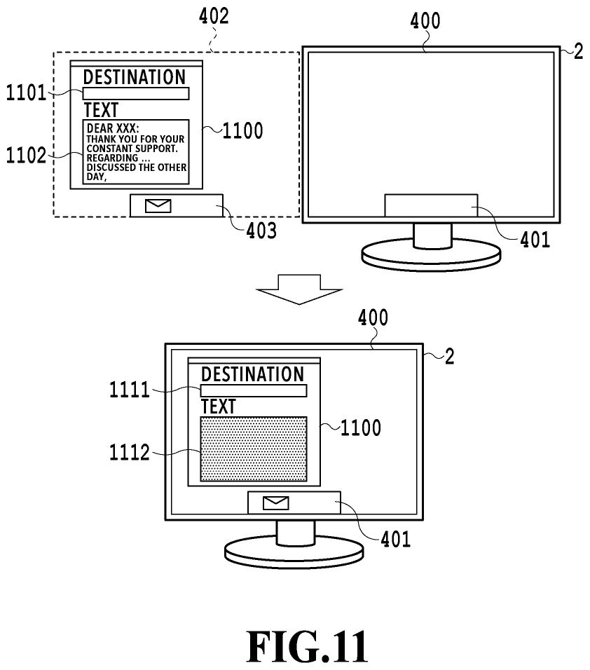

After that, the process returns to the flow in FIGS. 5 and S503 is executed. In S503, the editing unit 13 performs a process for making a form in a window invisible according to the form flag. FIG. 11 is a diagram showing an example of a case where a form is filled with a rectangle as a process for making the form invisible. In FIG. 11, the upper section shows a state before stopping a display on the virtual display 402, and a mailer window 1100 including two forms 1101 and 1102 is displayed. The form 1101 is an unfilled form in which the user has not yet entered any character or the like, and the form 1102 is a filled form in which a sentence being created has already been written. In this state, in a case where the display of the window 1100 on the HMD 3 is stopped, a new window 1110 is displayed on the real screen 400 of the monitor 2. The lower section of FIG. 11 shows a state after the display on the virtual display 402 is stopped, and it can be seen that the unfilled form 1101 is displayed as it is and the filled form 1102 is filled in and displayed so that no character or the like can be seen.

The process for making a form invisible may be a method other than filling in and, for example, a page may be scrolled so that a filled form becomes invisible. In the present modification example, whether to make a form invisible is determined for each form but may be determined in an even smaller unit within the form. For example, a character in a filled form may be replaced with a black circle and made invisible. This case can be implemented by information on the characters already entered in the form being saved as a portion of form information and referred to in S503. In the present modification example, a form in which text is to be entered is used as an example, but the present disclosure is not limited to this and for example, a check box, a combo box, a toggle switch, and the like may be used.

As described above, in the present embodiment, in a case where a display on the HMD is stopped, a window to be displayed on the monitor is edited so that the window displayed on the HMD is not displayed on the monitor as it is. This can prevent the window viewed by the user on the HMD from being displayed on the monitor as it is and being seen by others.

### Second Embodiment

In the present embodiment, in a use case where a mixed reality image is viewed with the HMD (see FIG. 1B described above), an aspect will be described that reduces an effect on an environment map caused by removing a specific object from a real image and increases optical consistency in the mixed reality image. Before starting a detailed description of the present embodiment, a problem to be solved by the present embodiment will be described in detail.

### Problem Acknowledgment

For example, in considering replacing a kitchen, a user can check harmony between a new kitchen under consideration for purchase and the user's own room based on a mixed reality image in which CG of the new kitchen is superimposed on an image of the user's own room. In this case, a method is known in which the current kitchen being installed is erased from a real image and then the CG of the new kitchen is superimposed. This is a technique called “diminished reality,” which makes it appear as if an object (hereinafter referred to as “diminishment object”) intended to be erased in a real image that reflects real space does not exist by complementing and overwriting the pixel values of a region for the diminishment object with the pixel values of the surroundings. In the above example, it is possible to avoid a situation where the current kitchen protrudes from the CG of the superimposed new kitchen and is seen by erasing the current kitchen from the real image. On the other hand, there is a technique called environment mapping that expresses the reflection of superimposed CG. The environment mapping is a technique for holding a surrounding environment reflected in the CG as image data (referred to as “environment map”) and expressing a reflection in the real space in the CG by referring to the environment map during rendering of the CG. In the environment mapping, the normal vector of a CG surface is used as an axis to determine the reflection direction of a line-of-sight vector from a virtual viewpoint to the surface, and the pixel of the environment map corresponding to the reflection direction is used for reflection expression in the CG. In this case, in a case where the reflection direction is changed according to a refractive index, refraction can also be expressed. This increases optical consistency in a generated mixed reality image. Optical consistency is a term that indicates how well the optical expression of a reflection, shadow, or the like in CG is consistent with reality. Using techniques such as diminished reality and an environment map makes it possible to generate a high-quality mixed reality image. However, in a case where the environment map includes a diminishment object, the diminishment object that should have disappeared affects a reflection in CG and decreases the optical consistency between real space and the CG. This is the problem to be solved by the present embodiment.

### Specific Examples of Situation Where Problem Arises

Specific examples of a situation where optical consistency in a mixed reality image is reduced by performing CG composition while a diminishment object is reflected in an environment map will be described.

### First Situation Example

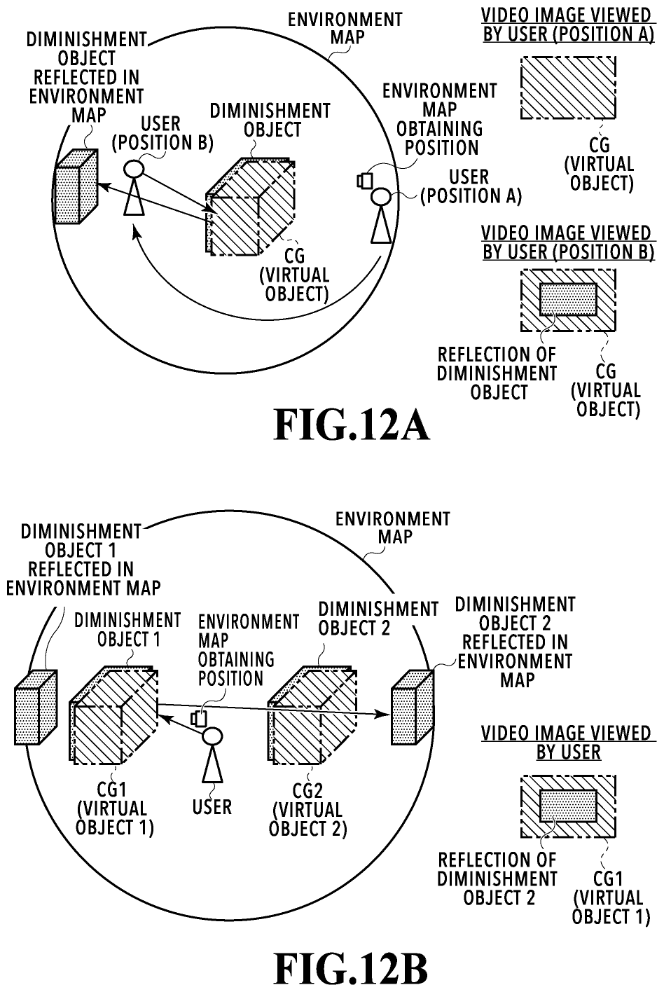

A first situation example is a situation where an environment map obtaining position and a user viewing position are different. FIG. 12A is a diagram for explaining the first situation example. Now, a user is standing facing a diminishment object (˜ virtual object) from position A and is viewing a mixed reality image (MR image) in which the diminishment object existing in reality is erased and CG (virtual object) is superimposed thereon. Here, the environment map used to render the CG is obtained in the environment map obtaining position (˜ position A). The environment map is generally held as, for example, an equirectangular image. Now, the diminishment object exists in a front direction as viewed from the environment map obtaining position (˜ position A) and is not reflected in the CG in a video image viewed by the user from position A. However, in a case where the user moves to position B, the diminishment object reflected in the environment map is used for reflection expression and is reflected in the CG in the video image viewed by the user.

### Second Situation Example

A second situation example is a situation where a user is sandwiched between diminishment objects. FIG. 12B is a diagram for explaining the second situation example. Now, the user is standing facing a diminishment object 1 (˜ virtual object 1) in a position between the diminishment object 1 and a diminishment object 2 and is viewing a mixed reality image (MR image) in which the diminishment objects 1 and 2 that exist in reality are erased and CG1 (virtual object 1) is superimposed thereon. Here, the environment map used to render the CG1 is obtained in the same position as the user's viewing position. Now, the diminishment object 1 exists in the front direction as viewed from the environment map obtaining position (˜ position A), and the diminishment object 2 exists in the opposite direction. Thus, the diminishment object 2 reflected in the environment map is used for reflection expression and is reflected in the CG1 in the video image viewed by the user. Similarly, in a case where the user views CG2, the diminishment object 1 reflected in the environment map is used for reflection expression and is reflected as a reflection in the CG2 in the viewed video image.

### Functional Configuration of Information Processing Apparatus

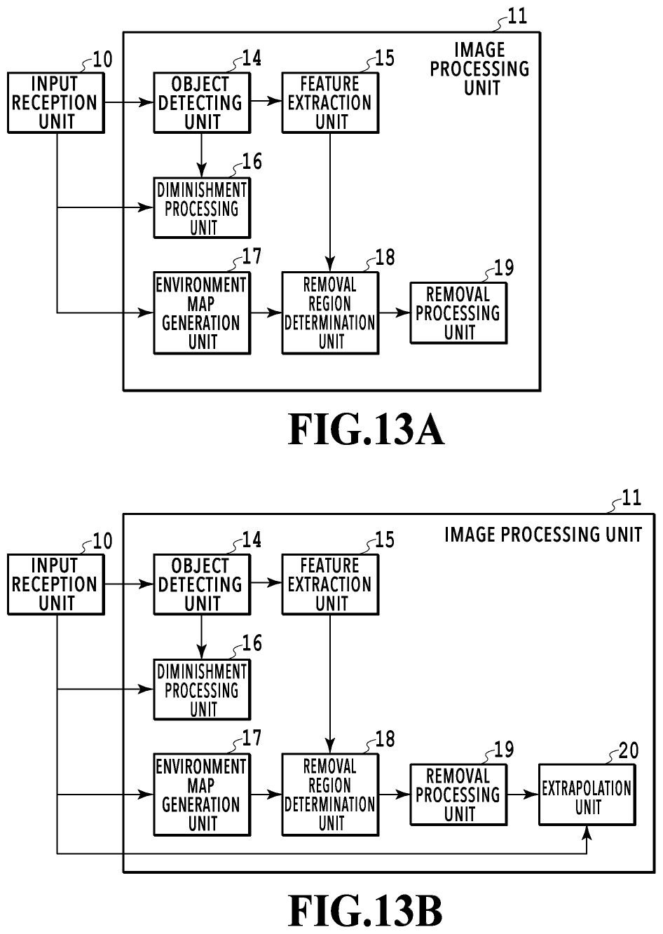

FIG. 13A is a block diagram showing an example of the software configuration (logical configuration) of an information processing apparatus 1 according to the present embodiment. In FIG. 13A, the information processing apparatus 1 includes an input reception unit 10 and an image processing unit 11, and the image processing unit 11 includes an object detecting unit 14, a feature extraction unit 15, a diminishment processing unit 16, an environment map generation unit 17, a removal region determination unit 18, and a removal processing unit 19. Each unit will be described below.

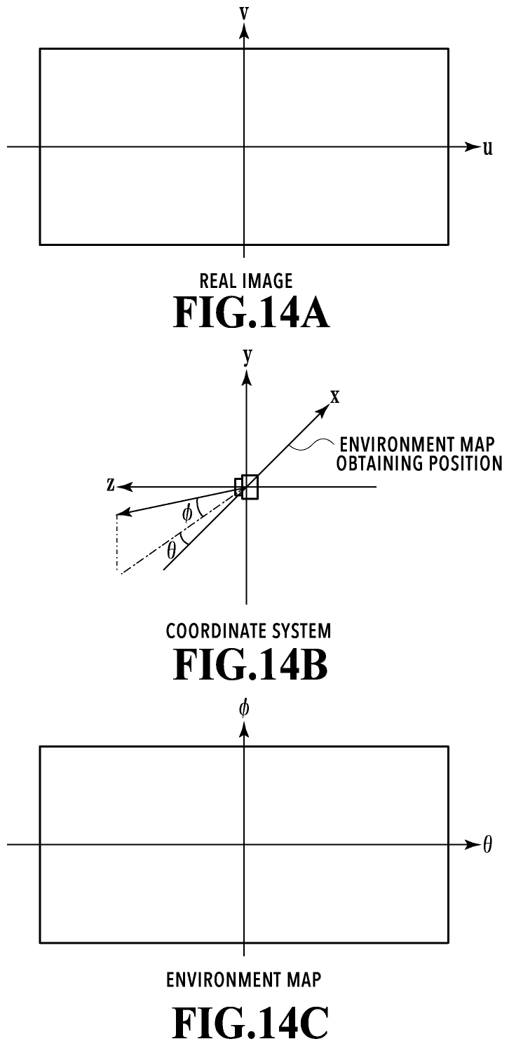

The input reception unit 10 receives various user inputs in addition to a real image captured with the HMD 3. As shown in FIG. 14A, the real image according to the present embodiment is in a uv coordinate system in which the horizontal direction is indicated by a u axis and the vertical direction is indicated by a v axis and has a color value of an RGB three-channel for each pixel. Obtained data on the real image is output to the object detecting unit 14, the diminishment processing unit 16, and the environment map generation unit 17.

The object detecting unit 14 detects a diminishment object in a real image. Through this detection, an object designated by a user as a target to be diminished among objects reflected in the real image is detected by a known method such as machine learning or pattern matching to obtain a region corresponding to the detected diminishment object and the type (class) of diminishment object. The region corresponding to the diminishment object is, for example, a rectangular region surrounding the diminishment object. Information on the rectangular region and class of the detected diminishment object is output to the feature extraction unit 15 and the diminishment processing unit 16.

The feature extraction unit 15 extracts feature information on the diminishment object reflected in the real image. This feature information includes three types of feature amounts: an object detection feature amount, an image feature amount, and a three-dimensional feature amount. The extracted feature information is output to the removal region determination unit 18.

The environment map generation unit 17 generates an environment map of real space where a user uses the HMD 3. As shown in FIG. 14B, a direction in an environment map obtaining position can be expressed using polar coordinates (θ, Φ), and an image obtained by quantizing the polar coordinates and mapping light at the polar coordinates is the environment map. FIG. 14C shows an environment map drawn on the equirectangular projection. Incidentally, the format of the environment map does not necessarily have to be the equirectangular projection but may be a cube map format, a spherical map, or the like. The generated environment map is output to the removal region determination unit 18.

The removal region determination unit 18 determines a removal region to be subjected to a removal process for removing a diminishment object from the environment map. Information on the determined removal region is output to the removal processing unit 19.

The removal processing unit 19 performs a complementation process on the removal region determined by the removal region determination unit 18 and removes the diminishment object from the environment map.

### Operation Flow of Information Processing Apparatus

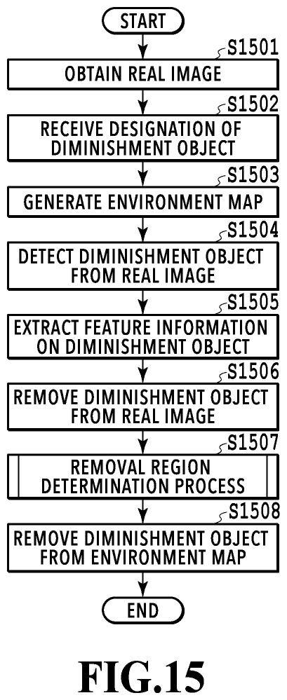

FIG. 15 is a flowchart showing an operation flow in the information processing apparatus 1 according to the present embodiment. A series of steps shown in the flowchart in FIG. 15 is executed in units of frames. In the following description, each symbol “S” means a step.

In S1501, the input reception unit 10 obtains real image data from the HMD 3. As described above, a real image obtained here is an image captured with the RGB camera 201.

In S1502, the input reception unit 10 receives a user input designating a diminishment object among the objects reflected in the real image obtained in S1501. The diminishment object may be designated, for example, with a hand gesture in which a user uses the user's finger to point to the diminishment object. For example, in the case of a hand gesture, the RGB camera 201 of the HMD 3 detects the user's finger using, for example, known machine learning, and obtains the image coordinates of a fingertip to receive the designation of the diminishment object. Incidentally, coordinate information on the diminishment object that the user has designated and saved in advance may be read and obtained from the HDD 105. Further, for example, the uv coordinates of an object pointed to by the user may be obtained, or user designation may be received through the input device 107 such as a mouse.

In S1503, the environment map generation unit 17 generates an environment map. For example, the environment map is generated by reading from the HDD 105 data on a real image (360-degree image) that has been obtained by capturing real space and saved in advance with a 360-degree camera and converting the 360-degree image into an equirectangular image. Here, capturing the environment map in advance with the 360-degree camera may make the environment map obtaining position and the position of the HMD 3 different and result in an inappropriate positional relationship between reflections. In order to ease such a situation, a positional shift in the environment map may be corrected by a known warping technique. Further, the environment map may be generated in real time in the user's position by installing a 360-degree camera on the top of the HMD 3 or installing a plurality of cameras around the HMD 3 and combining video images. Incidentally, the method for generating the environment map is not limited to the method using the 360-degree camera. For example, an environment map may be generated by extrapolating a region outside the angle of view by complementation using machine learning such as deep learning based on an environment map of a range corresponding to the angle of view of a camera having an angle of view of less than 360 degrees (a precondition for a first modification example described later). Further, a visible range may be sequentially updated for the environment map generated using the video images obtained with the 360-degree camera (a precondition for a second modification example described later). In this case, an orientation at the time of activating the HMD 3 is set to (θ, Φ)=(0, 0), and the environmental map is updated for the angle of view of the RGB camera 201. In a case where the orientation of the HMD 3 changes, obtaining the orientation (θt, Φt) with a gyroscope sensor (not shown) and updating the environmental map for the angle of view of the RGB camera 201 with the orientation (Ot, Pt) used as the center are repeated. At this time, the orientation of the HMD may be estimated by a known SLAM technique instead of the gyroscope sensor. Further, the generation may be performed by a hybrid method in which a region outside the angle of view in the original environmental map is extrapolated by machine learning and a region captured with the RGB camera 201 at least once is updated by the captured image.

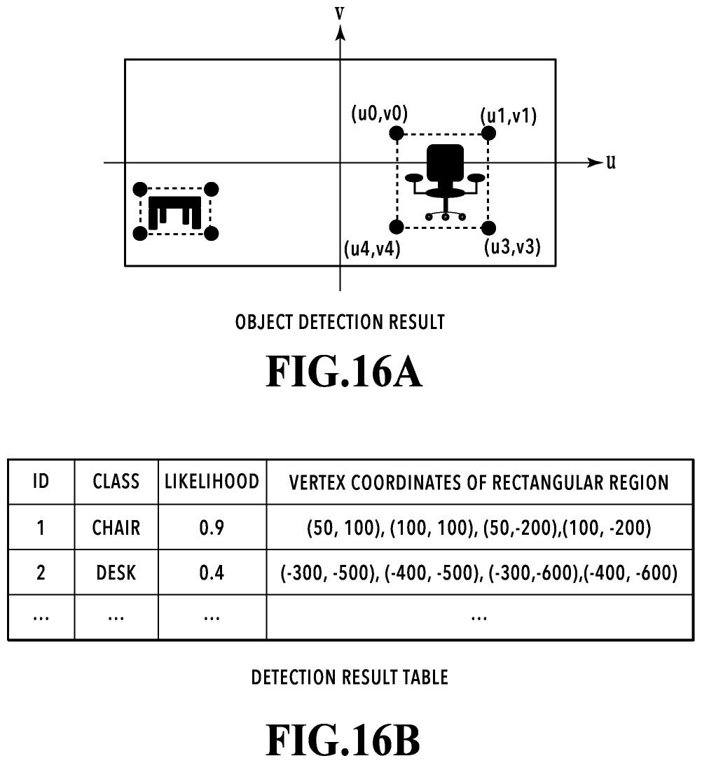

In S1504, the object detecting unit 14 performs a process for detecting the diminishment object designated by the user in the real image obtained in S1501. A specific procedure is as follows. First, image analysis by known machine learning is performed on the real image to detect an object included in the real image. FIG. 16A is an example of a detection result and shows a rectangular region surrounding an object reflected in the real image. Based on the detection result thus obtained, an ID, a class, the likelihood of a class, and the vertex coordinates of the rectangular region are obtained for each object (see the table in FIG. 16B). Among the detected objects, an object having coordinates closest to the coordinates designated by the user is then specified as a diminishment object, and information on the class and vertex coordinates (uₘ, vₘ) {m=0, 1, 2, 3} is output as a detection result. Incidentally, the shape of a region representing a detected object does not necessarily have to be rectangular. For example, a known semantic region division technique may be applied to detect a pixel region including the coordinates designated by the user as a diminishment object region and output information on the pixel region as a detection result.

In S1505, the feature extraction unit 15 extracts an object detection feature amount, an image feature amount, and a three-dimensional feature amount as feature information on the diminishment object based on the detection result in S1504. A specific extraction method is as follows.

### Extraction of Object Detection Feature Amount

For the object detection feature amount, the class of the diminishment object included in the above detection result is obtained.

### Extraction of Image Feature Amount

Image feature amount means color information on a diminishment object in a real image. First, a rectangular region for the diminishment object is cropped from the real image obtained in S1501, and the pixel value of the cropped region is obtained. Here, the rectangular region for the diminishment object may also include its background. In this case, it is only required that the background be separated by a known background separation technique to use a value obtained by calculating the average RGB value of only the pixels of the diminishment object, which is a foreground, as the image feature amount. Incidentally, the object detecting unit 14 may perform cropping and include a cropped image in the detection result. This case does not need the cropping in this step. Incidentally, the value obtained as the image feature amount is not limited to the average RGB value but may be another statistical value such as a median value or may also be the pixel value of the center coordinates of a diminishment object region in the real image and does not necessarily have to be one value. For example, colors constituting the diminishment object may be clustered by a known clustering technique such as the X-means method, and a list of the average RGB values of clusters may be used as the image feature amount.

### Extraction of Three-Dimensional Feature Amount

Three-dimensional feature amount means vertex coordinates in the polar coordinate system of the rectangular region for the diminishment object in the real image. Thus, the vertex coordinates of the rectangular region in the uv coordinate system are converted into the polar coordinate system with the HMD 3 as the origin and obtained. First, image coordinates are converted into an orthogonal coordinate system using the intrinsic parameter K of the RGB camera 201 of the HMD. Here, the intrinsic parameter K is expressed by a principal point (Cₓ, C_{y}) and a focal length (fₓ, f_{y}) as shown in Equation (1) below. The intrinsic parameter K obtained in advance by a known camera calibration technique and saved in a storage unit such as the HDD 105 is read.

$$K = ( \begin{matrix}f x & 0 & c x \\ 0 & f y & c y \\ 0 & 0 & 1\end{matrix} ) \qquad Equation ( 1 )$$

The image coordinates are converted into a Cartesian coordinate system using Equation (2) below.

$$( \begin{matrix}x \\ y \\ z\end{matrix} ) = {K}^{- 1} ( \begin{matrix}u \\ v \\ 1\end{matrix} ) \qquad Equation ( 2 )$$

The vertex coordinates (θₘ, Φₘ) {m=0, 1, 2, 3} in the polar coordinate system are then obtained from the obtained orthogonal coordinate system using Equations (3) and (4) below.

$$θ = Arccos ( z / √ ( {x}^{2} + {y}^{2} + {z}^{2} ) ) \qquad Equation ( 3 )$$

$$Φ = sgn ( y ) Arccos ( z / √ ( {x}^{2} + {y}^{2} ) ) \qquad Equation ( 4 )$$

In this way, the vertex coordinates (θₘ, Φₘ) {m=0, 1, 2, 3} in the polar coordinate system are obtained by applying the conversion process according to Equations (1) to (4) above to the vertex coordinates (uₘ, vₘ) {m=0, 1, 2, 3} in the uv coordinate system.

In S1506, the diminishment processing unit 16 performs a diminishment process on the real image obtained in S1501 to remove the diminishment object from the real image. In this case, for example, an image complementing technique using known machine learning is applied to remove the diminishment object from the real image.

In S1507, the removal region determination unit 18 calculates a region corresponding to the diminishment object from the environment map and determines the region as a removal region. Details of the removal region determination process will be described later.

In S1508, the removal processing unit 19 removes the diminishment object from the environment map generated in S1503 based on the removal region determined in S1507. Also in this case, for example, an image complementing technique using known machine learning is applied to the removal region to remove the diminishment object from the environment map.

The above are the contents of the operation flow in the information processing apparatus 1 according to the present embodiment. Incidentally, the real image has been described as an RGB three-channel one in the present embodiment but may be, for example, a five-channel image or a one-channel black and white image.

### Details of Removal Region Determination Process

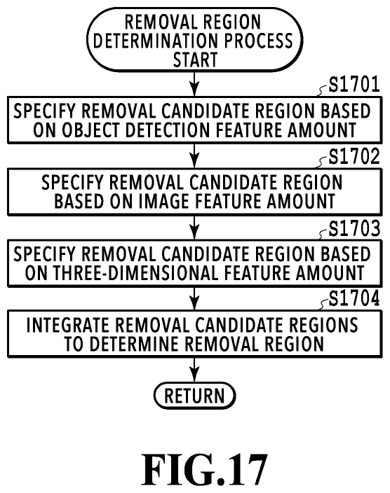

FIG. 17 is a flowchart showing details of the removal region determination process in S1507. A description will be given below with reference to the flowchart in FIG. 17.

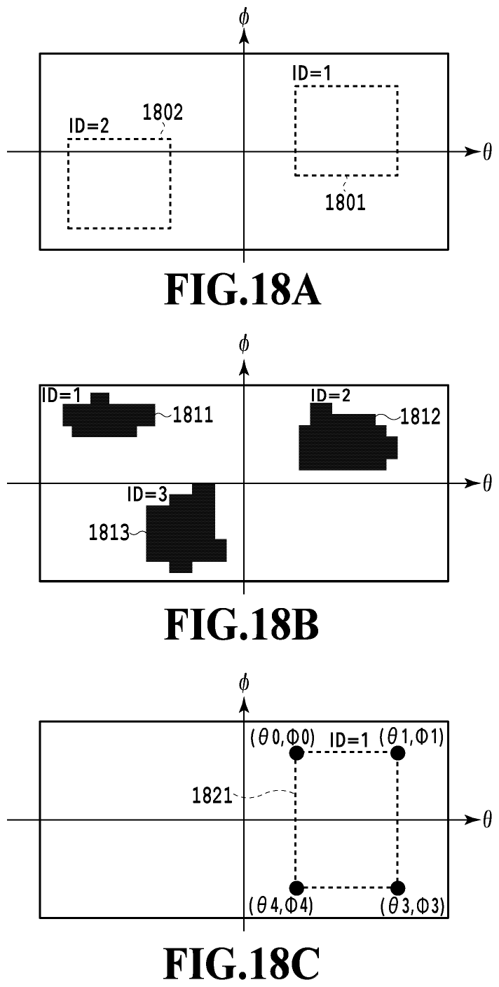

In S1701, a removal candidate region based on an object detection feature amount is specified. Specifically, an object corresponding to the class of a diminishment object as the object detection feature is found from an environment map, and a region for the object is set as a removal candidate region. First, the above-mentioned object detection technique is applied to the environment map to obtain a detection result similar to that in S1504. However, the vertex coordinates are expressed in a uv coordinate system in S1504 above but are in the polar coordinate system in this step. Next, based on the obtained detection result, a region in the environment map in which an object of the same class as the diminishment object exists is specified as a removal candidate region based on the object detection feature amount. The removal candidate region thus specified based on the object detection feature amount is held as an object detection feature region image with the same number of pixels as that of the environment map. FIG. 18A is an example of an object detection feature region image, and a rectangular region in which an object of the same class as the diminishment object is detected is indicated by a dashed line. Further, an ID is assigned to each rectangular region, and pixels constituting each region hold the ID value of a region with which the pixels are affiliated. In the example in FIG. 18A, two objects of the same class as the diminishment object are detected, and each pixel in a rectangular region 1801 holds ID=1, each pixel in a rectangular region 1802 holds ID=2, and ID=0 is held in the other regions. In the present embodiment, the object detection feature region image is generated in which the detected object is indicated by the rectangular region, but the present disclosure is not limited to this. For example, background separation may be applied to the rectangular region in the environment map to generate an object detection feature region image in which an ID is assigned only to the pixels of a foreground portion and an object detection feature region image corresponding to the foreground portion and in which the shape of the object is indicated in more detail.

In S1702, a removal candidate region based on an image feature amount is specified. Specifically, on the assumption that a region of a color close to the average RGB value extracted in S1505 is a region corresponding to the diminishment object, the region is set as a removal candidate region. It is only required that the region of a close color be a region whose color difference ΔE is equal to or less than a predetermined value. In a case where the environment map obtaining position is different from the position of the HMD 3, a lighting environment and a viewpoint from which the diminishment object is captured change, and a color difference is likely to become large. In order to prevent the diminishment object from affecting environment mapping for CG at a color name level, it is desirable that the region of a close color be, for example, a region having ΔE 20 or less. ΔE 20 means a color difference at a level at which color names match. In a case where the image feature amount is a list of the average RGB values of the clusters, for example, in a case where at least one of the average RGB values in the list is ΔE 20 or less, it is only required that the region be determined to be a region for a diminishment object and then a connected component be obtained. The removal candidate region based on the image feature amount thus specified is held as an image feature region image with the same number of pixels as that of the environment map. FIG. 18B is an example of the image feature region image in which connected components of pixels with ΔE less than 20 are indicated as black pixel blocks. Here, the connected component is a combination of adjacent pixels with ΔE less than 20. An ID is assigned to each black pixel block, and pixels constituting each region hold the ID value of a region with which the pixels are affiliated. In the example in FIG. 18B, three connected components (black pixel blocks) are obtained, each pixel in a black pixel block 1811 holds ID=1, each pixel in a black pixel block 1812 holds ID=2, each pixel in a black pixel block 1813 holds ID=3, and ID=0 is held in the other regions.

In S1703, a removal candidate region based on a three-dimensional feature amount is specified. Specifically, a region in the environment map corresponding to the vertex coordinates (θₘ, Φₘ) {m=0, 1, 2, 3} in the polar coordinate system extracted in S1505 is set as the removal candidate region. The removal candidate region thus specified based on the three-dimensional feature amount is held as a three-dimensional feature region image with the same number of pixels as that of the environment map. FIG. 18C is an example of the three-dimensional feature region image, and a region at the vertex coordinates (θₘ, Φₘ) {m=0, 1, 2, 3} in the polar coordinate system is indicated by a dashed line. In the example in FIG. 18C, each pixel in a region 1821 holds ID=1, and ID=0 is held in the other regions.

In S1704, a region obtained by integrating the three types of removal candidate regions (i.e., the object detection feature region image, the image feature region image, and the three-dimensional feature region image) specified in S1701 to S1703 is determined to be a removal region. In a case where the removal region is determined based only on the object detection feature amount, in a case where an object of the same class is detected in addition to the diminishment object, the object may become the removal region (see FIG. 18A described above). Further, in a case where the removal region is determined based only on the image feature region image, an object other than the diminishment object having a similar image feature amount also becomes the removal region (see FIG. 18B described above). In order to prevent such errors, an AND region of the three types of removal candidate regions is first obtained. That is, a region where regions whose IDs are not 0 overlap in the object detection feature region image, the image feature region image, and the three-dimensional feature region image is obtained. Taking an AND (logical AND) makes it possible to obtain a removal region based on a plurality of feature amounts and prevent objects other than the diminishment object from being included in the removal region as much as possible. On the other hand, simply taking an AND tends to make the region smaller than the original region for the diminishment object. This is because in a case where the diminishment object has a plurality of colors, only one of the colors may show the image feature region, which may be smaller than the original region for the diminishment object. Further, the viewpoint from which the diminishment object is viewed may differ between a real video image obtaining position and an environment map obtaining position, and the shape of the object may be different depending on the viewpoint. Thus, the region indicated by the three-dimensional feature region image may also be smaller than the original region for the diminishment object. In order to prevent the removal region from being too small, the OR (logical sum) of the AND regions in the object detection feature region image, image feature region image, and three-dimensional feature region image is taken. Now, assume that the OR region is, for example, a region where a pixel value=1 in the object detection feature region image, a region where a pixel value=2 in the image feature region image, and a region where a pixel value=1 in the three-dimensional feature region image. In this case, a region obtained by adding together a region whose pixel value is 1 in the object detection feature region image, a region whose pixel value is 2 in the image feature region image, and a region whose pixel value is 1 in the three-dimensional feature region image is determined to be a removal region.

The above are the details of the removal region determination process according to the present embodiment. In the present embodiment, an object detection feature amount, an image feature amount, and a three-dimensional feature amount are extracted as feature amounts, and removal candidate regions for a diminishment object are obtained from each feature amount and integrated to determine a removal region. However, it is not essential to integrate three removal candidate regions, and for example, two of these removal candidate regions may be integrated.

### First Modification Example

In the case of extrapolating an environment map of a range corresponding to the outside of the angle of view of a camera having an angle of view of less than 360 degrees, a diminishment object on an environment map on which the extrapolation is based may have an effect. Thus, in order to reduce the effect, a method for removing the diminishment object from the base environment map before performing extrapolation will be described as a first modification example.

### Specific Example of Situation Where Problem Arises

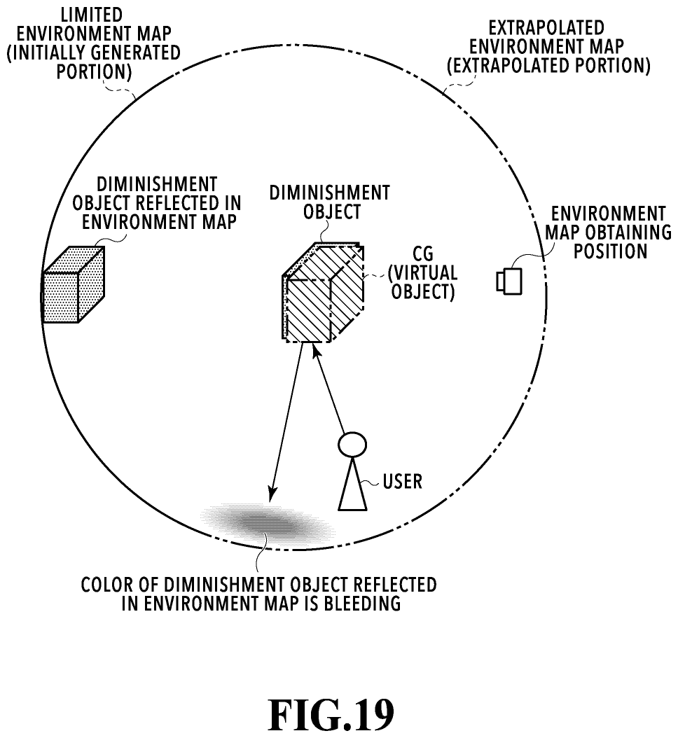

FIG. 19 is a diagram for explaining a situation example according to the present modification example. First, an environment map (hereinafter referred to as “limited environment map”) in a limited range indicated by a solid arc in FIG. 19 is generated using a video image obtained with a camera having an angle of view of less than 360 degrees from an environment map obtaining position facing a diminishment object. For a range that corresponds to the outside of the angle of view of the camera and cannot be covered with the limited environment map, extrapolation is performed, for example, by deep learning to generate an environment map (hereinafter referred to as “extrapolated environment map”) in a range indicated by a two-dot chain arc in FIG. 19. In this case, in a case where the extrapolation is performed while the diminishment object reflected in the limited environment map indicated by the solid line remains as it is, for example, a phenomenon may occur in which the color of the diminishment object bleeds into the extrapolated portion. In such a case, for example, in a case where a user observes CG from a side face, the color bleeding reflected in the extrapolated environment map behind the user is used for reflection expression and is reflected in the CG in a viewed video image.

### Functional Configuration of Information Processing Apparatus

FIG. 13B is a block diagram showing an example of the software configuration (logical configuration) of the information processing apparatus 1 according to the present modification example. A difference from the block diagram in FIG. 13A is that the removal processing unit 19 is followed by the extrapolation unit 20 with which information from the input reception unit 10 is also provided. The input reception unit 10 outputs, to the extrapolation unit 20, angle-of-view information indicating the angle of view (an angle of view of less than 360 degrees) of a camera that captures a video image used by the environment map generation unit 17 during generation. The removal processing unit 19 removes a diminishment object from a limited environment map of a range corresponding to an angle of view of less than 360 degrees generated by the environment map generation unit 17 and outputs the limited environment map after the removal to the extrapolation unit 20. The extrapolation unit 20 extrapolates the limited environment map of a range corresponding to the outside of the angle of view of the camera.

### Operation Flow of Information Processing Apparatus

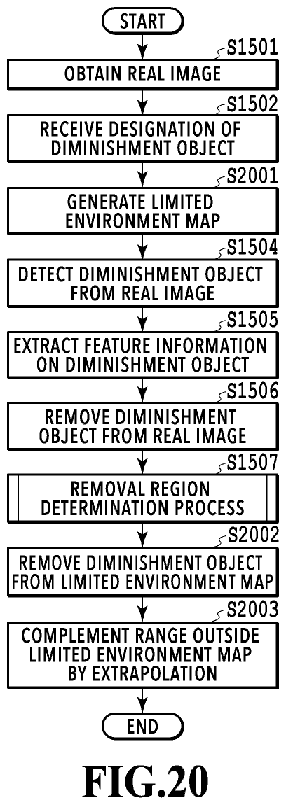

FIG. 20 is a flowchart showing an operation flow in the information processing apparatus 1 according to the present modification example. The same step number is given to a step having the same contents as in the flowchart in FIG. 15 described above, and a description thereof will be omitted. Details of the present modification example will be described below with reference to the flowchart in FIG. 20.

In S2001 replacing S1503, the environment map generation unit 17 generates a limited environment map of a range corresponding to an angle of view of less than 360 degrees. In S2002 replacing S1508, the removal processing unit 19 removes a diminishment object reflected in the limited environment map. In S2003, the extrapolation unit 20 then extrapolates the outside of the range in the limited environment map. That is, the environment map of the range corresponding to the outside of the angle of view indicated by input angle-of-view information is inferred (complemented) by, for example, known deep learning. The above is the operation flow of the information processing apparatus 1 according to the present modification example.

In the present modification example, removing the diminishment object reflected in the partial environment map obtained in advance before performing the extrapolation processing can reduce adverse effects that the diminishment object reflected in the environment map has during the extrapolation.

### Second Modification Example

In a case where a range captured with a camera in an environment map is updated sequentially, a certain diminishment object may be reflected multiple times in the environment map. A method for removing an unnecessary diminishment object of such a diminishment object reflected multiple times from the environment map will be described as a second modification example.

### Specific Example of Situation Where Problem Arises

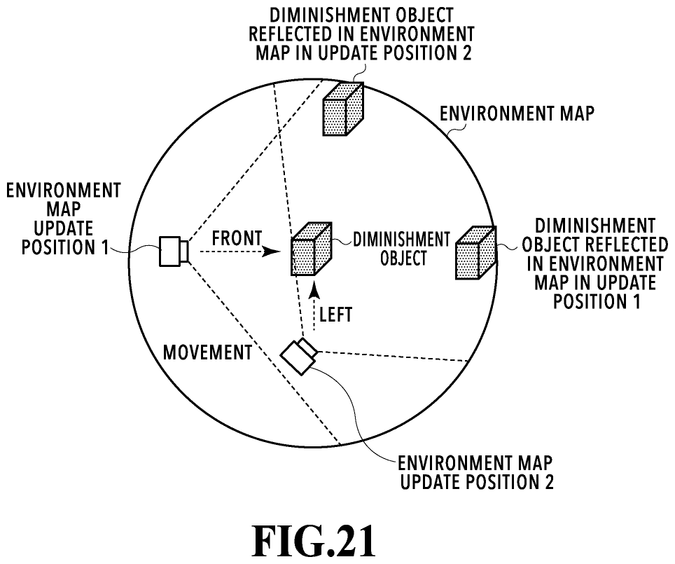

FIG. 21 is a diagram for explaining a situation example according to the present modification example. Now, a solid-lined environment map covering the entire range is obtained with a 360-degree camera. Capturing is performed in an environment map update position 1 where a diminishment object is viewed from the front, and the environment map of a range corresponding to the angle of view indicated by a dashed line is first updated based on an obtained video image. At this time, the diminishment object is reflected in the range in the environment map. Assume that after that, a user moves to an environment map update position 2 where the diminishment object is viewed on the left, capturing is performed again, and the environment map of the range corresponding to the angle of view indicated by the dashed line is updated based on an obtained video image. Also in this case, the diminishment object is reflected in the range in the environment map. As a result, a plurality of diminishment objects remain reflected on the environment map until the next update based on a video image in which no diminishment object is reflected is performed for the same range.

### Functional Configuration of Information Processing Apparatus

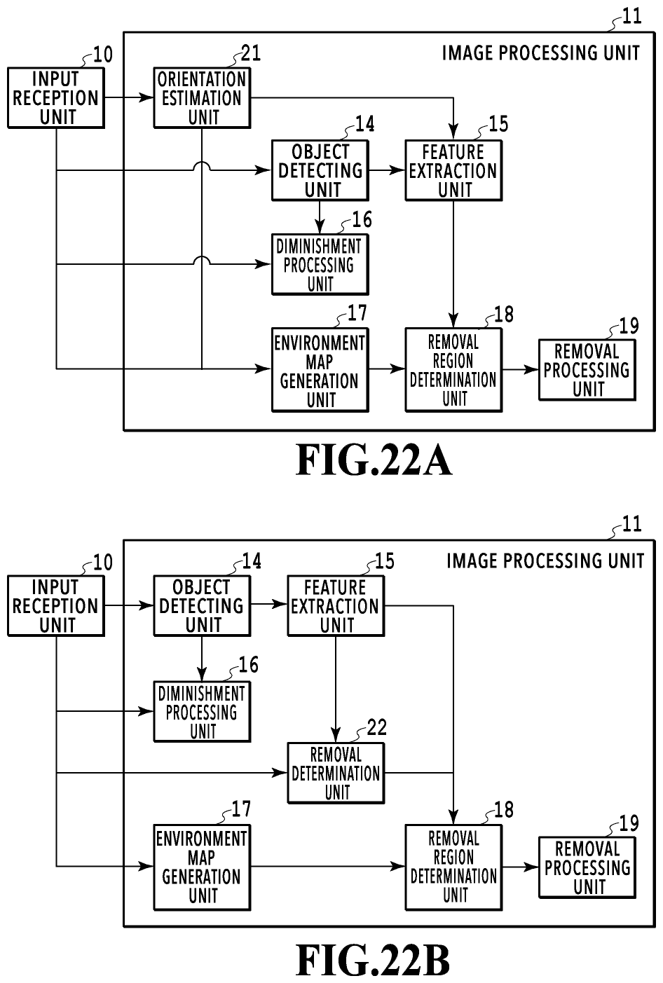

FIG. 22A is a block diagram showing an example of the software configuration (logical configuration) of the information processing apparatus 1 according to the present modification example. A difference from the block diagram in FIG. 13A is that an orientation estimation unit 21 is added and is also provided with information from the input reception unit 10. The input reception unit 10 according to the present modification example further receives an input of a depth map and outputs the depth map to the orientation estimation unit 21. The orientation estimation unit 21 then estimates the orientation of the HMD 3 based on the depth map. Orientation information as an estimation result is output to the feature extraction unit 15 and the environment map generation unit 17.

### Operation Flow of Information Processing Apparatus

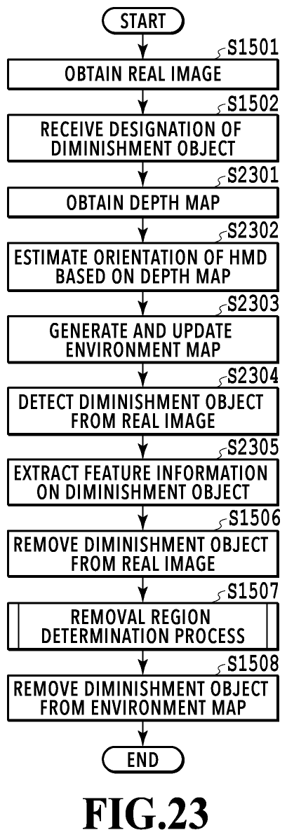

FIG. 23 is a flowchart showing the flow of processing in the information processing apparatus 1. The same step number is given to a step having the same contents as in the flowchart in FIG. 15 described above, and a detailed description thereof will be omitted. Details of the present modification example will be described below with reference to the flowchart in FIG. 23.

In S2301, the input reception unit 10 obtains a depth map obtained using the distance sensor 202 or the like. The depth map is a map having the same number of pixels as that of a real image and showing a distance from a camera for each pixel of an image, and a depth is stored in pixels corresponding to respective pixels of a real image captured with the RGB camera 201.

In S2302, the orientation estimation unit 21 estimates the orientation of the HMD 3 based on the depth map obtained in S2301. For example, a known simultaneous localization and mapping (SLAM) technique is applied to the orientation estimation to obtain a rotation matrix R and a translation matrix T that convert the initial orientation of the HMD 3 to a current orientation as orientation information. Here, the rotation matrix R and the translation matrix T are referred to as extrinsic parameters and, in the present embodiment, are described as the initial orientation in a case where the power of the HMD 3 is turned on.

In S2303, the environment map generation unit 17 generates/updates an environment map. That is, the environment map generation unit 17 updates the environment map within the current angle of view of the RGB camera 201 at any time. In this update, an RGB value and orientation information on the HMD 3 are stored in each pixel of the environment map.

In S2304, the object detecting unit 14 detects a diminishment object in the real image to obtain the class and vertex coordinates (uₘ, vₘ) {m=0, 1, 2, 3} of the detected diminishment object.

In S2305, the feature extraction unit 15 extracts an object detection feature amount, an image feature amount, and a three-dimensional feature amount as feature information on the diminishment object based on the detection result in S2304. Since the method for extracting the object detection feature amount and the image feature amount is the same as in the above embodiment, a description thereof will be omitted, and the extraction of the three-dimensional feature amount will be described here.

The feature extraction unit 15 according to the present modification example extracts the position (x_{w}, y_{w}, z_{w}) of the diminishment object in a world coordinate system as the three-dimensional feature amount. To that end, the center coordinates (uₐᵥₑ, vₐᵥₑ) of the diminishment object in an image coordinate system are obtained from the vertex coordinates (uₘ, vₘ) {m=0, 1, 2, 3} of the diminishment object obtained in S2304. A depth d at (uₐᵥₑ, vₐᵥₑ) is then obtained from the depth map obtained in S2301. After that, the center coordinates of the diminishment object in the image coordinate system are converted into coordinates (x_{w}, y_{w}, z_{w}), which are the activation orientation of the HMD 3, in the world coordinate system using Equation (5) below.

$$( \begin{matrix}{x}_{w} \\ {y}_{w} \\ {z}_{w}\end{matrix} ) = {R}^{T} ( {dK}^{- 1} ( \begin{matrix}{u}_{ave} \\ {v}_{ave} \\ 1\end{matrix} ) - T ) \qquad Equation ( 5 )$$

In Equation (5) above, K represents an intrinsic parameter (the focal length of a camera lens and the position of an optical axis), and R and T represent the current extrinsic parameters of the HMD 3.

The process from S1506 onwards is as described with reference to the flow in FIG. 15 above. That is, the diminishment process is executed on the real image obtained in S1501 (S1506), and the removal region determination process is executed (S1507). Details of the removal region determination process will be described later. Based on the determined removal region, the diminishment object is then removed from the environment map generated and updated in S2303 (S1508). The above is the operation flow of the information processing apparatus 1 according to the present modification example.

### Details of Removal Region Determination Process

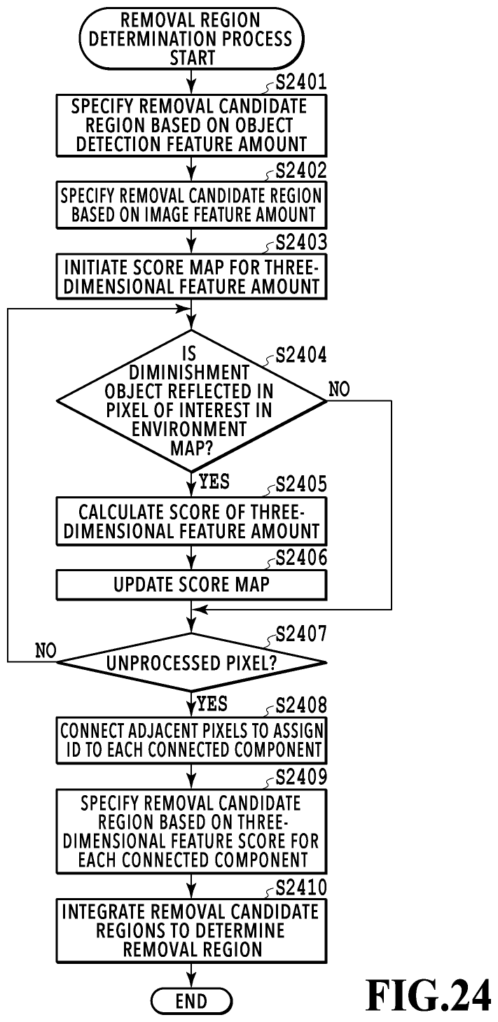

FIG. 24 is a flowchart showing details of the removal region determination process in S1507 according to the present modification example. A description will be given below with reference to the flowchart in FIG. 24.

In S2401, as in S1701 described above, a removal candidate region is specified based on an object detection feature amount. In addition, for the specified removal candidate region, the likelihood of an object included in the table obtained in S2304 (see FIG. 16B described above) is linked to an ID and held as an “object detection score.” In the example in FIG. 18A described above, an object detection score corresponding to the region whose ID is 1 and an object detection score corresponding to the region whose ID is 2 are held.

In S2402, as in S1702 described above, a removal candidate region based on an image feature amount is specified. In addition, for the specified removal candidate region, the average ΔE of diminishment objects in regions corresponding to the IDs is held as an “image feature score.” In the example in FIG. 18B described above, in a case where a plurality of removal candidate regions with similar image feature amounts are specified for diminishment objects corresponding to ID=1, 2, 3, the average value of color differences ΔE for each pixel in the respective removal candidate regions is held as an “image feature score.”

In S2403, a score map for the three-dimensional feature amount is initialized. This score map has the same number of pixels and shape as those of an environment map and stores in each pixel the score of a three-dimensional feature (hereinafter referred to as “three-dimensional feature score”) corresponding to the pixel position of the environment map. In this step, each pixel of this score map is initialized to “0.” A method for calculating the three-dimensional feature score will be described later.

In S2402, a step to be executed next is determined depending on whether a diminishment object is reflected in a pixel of interest (θ_{I}, Φᵢ) among pixels constituting the environment map. Here, in a case where the coordinates (x_{w}, y_{w}, z_{w}) of the diminishment object in the world coordinate system are within the angle of view of an image captured in the orientation of the HMD 3 at the time of updating of the pixel of interest (θ_{I}, Φᵢ), it is determined that the diminishment object is reflected in the pixel of interest. At this time, this determination is made by converting the coordinates (x_{w}, y_{w}, z_{w}) in the world coordinate system into the coordinates (uᵢ, vᵢ) in the image coordinate system using Equation (6) below.

$$s ( \begin{matrix}{u}_{i} \\ {v}_{i} \\ 1\end{matrix} ) = K ( {R}_{i} ( \begin{matrix}{x}_{w} \\ {y}_{w} \\ {z}_{w}\end{matrix} ) + {T}_{i} ) \qquad Equation ( 6 )$$

In Equation (6) above, “K” is an intrinsic parameter, and “s” is a coefficient such that the third element of the 3×1 matrix (uᵢ, vᵢ, 1) on the left side is 1. In a case where the coordinates (uᵢ, vᵢ) in the image coordinate system obtained using Equation (6) are within the range of the real image obtained in S1501, it is determined that the pixel of interest is within the angle of view, and S2403 is then executed. On the other hand, in a case where the coordinates (uᵢ, vᵢ) in the image coordinate system obtained using Equation (6) above are out of the range of the real image obtained in S1501, it is determined that the pixel of interest is outside the angle of view, and S2405 is then executed.

In S2405, a three-dimensional feature score for the pixel of interest (θ_{I}, Φᵢ) is calculated. The three-dimensional feature score indicates how much the position of the HMD 3 has moved from an initial position in a case where the pixel value of the pixel of interest in the environment map is updated. The more the orientation of the HMD 3 changes from the time of an update in the environment map, the more the viewpoint from which the diminishment object is viewed changes. Unless the object is origin-symmetrical, it is considered that the shape differs depending on the angle at which the object is viewed, and since the reliability of the three-dimensional feature amount tends to be low, the amount of movement from the initial position is used as a score. The three-dimensional feature score can be obtained, for example, using Equation (7) below.

Three-dimensional feature score=1/|Tᵢ|(if |Tᵢ|>1) Equation (7)

In Equation (7) above, |Tᵢ| represents the norm (magnitude) of a translation vector.

In S2406, the three-dimensional feature score obtained in S2405 is stored in the position of the pixel of interest (01, Di) in the score map, and the score map is updated.

In S2407, it is determined whether all pixels in the environment map have been processed, and in a case where there is an unprocessed pixel, the process returns to S2404 and continues. On the other hand, in a case where all pixels have been processed, S2408 is executed next.

In S2408, adjacent pixels whose pixel value is not “0” are connected to each other in the score map obtained through the process up to this point. An ID is then assigned to each of the obtained connected components.

In S2409, a removal candidate region based on the three-dimensional feature amount is specified based on a three-dimensional feature score for each region corresponding to a connected component. Specifically, a three-dimensional feature region image is generated in which an ID value is held in a pixel constituting a region corresponding to the connected component and “0” is held in a pixel constituting the other regions. This three-dimensional feature region image is the same as in FIG. 18C above. However, in the present modification example, a plurality of three-dimensional feature regions may be included. The average value of the three-dimensional feature scores is then calculated for each region corresponding to a connected component (i.e., for each ID).

In S2410, a region obtained by integrating the three types of removal candidate regions (i.e., the object detection feature region image, the image feature region image, and the three-dimensional feature region image) specified in S2401, S2402, and S2409 is determined to be a removal region. In the present modification example, integration is performed in consideration of a possibility that a plurality of diminishment objects are reflected in the environment map. Specifically, a region (AND region) where regions whose pixel values are not “0” overlap in the above three types of feature region images is first obtained. For each of the obtained plurality of AND regions, the scores (the object detection score, the image feature score, and the three-dimensional feature score) of the object detection region, image feature region, and three-dimensional feature region including the AND region are added up. In a case where the score after the addition is less than a threshold, the AND region is not included in the removal region. After that, as in S1704, the OR (logical sum) of regions having the pixel values of the object detection feature region image, image feature region image, and three-dimensional feature region image including an AND region with a score after the addition equal to or greater than the threshold is taken to determine a removal region.

The above are the contents of the removal region determination process according to the present modification example. In S2409, instead of threshold processing, regions with a high score corresponding to the number of three-dimensional feature regions in the environment map where the diminishment object is reflected may be integrated and be a removal region. In this case, first, the number of regions corresponding to connected components is set to N. Next, an AND region only in the image feature region and the object detection feature region is obtained. The scores are then added up for the one or more obtained AND regions. That is, the image feature score and the object detection score corresponding to IDs constituting the respective AND regions are added together. Among the one or more AND regions, the top N summed scores are excluded from the removal region. Finally, an OR is taken to determine a removal region. In this way, the number of diminishment objects reflected in the environment map may be estimated based on the three-dimensional feature amount to calculate removal regions corresponding to the number based on the other feature amounts.

As described above, according to the present modification example, in a case where a range captured with a camera in an environment map is updated sequentially, even in a case where a certain diminishment object is reflected multiple times in the environment map, it is possible to remove an unnecessary diminishment object.

### Third Modification Example

For example, in the case of a device with insufficient memory capacity such as a mobile terminal, only an environment map with a resolution of only about 1 pixel per degree (ppd) may be generated. In this case, an object cannot be sufficiently resolved or detected, and a diminishment object cannot be appropriately removed from the environment map. In such a case, higher optical consistency can be obtained by not performing any removal process. In the case of a virtual object made of a material that causes some internal scattering, a low-resolution environment map may be sufficient. However, even in such a case, in a case where the color of the diminishment object is the only color in a real image, for example, the color is used for reflection expression in CG, which reduces optical consistency. To address this, a method for removing the color of the diminishment object from the environment map is conceivable. However, in a case where the color of the diminishment object is uniformly removed from the environment map, there is a drawback in that in a case where there is an object of a similar color other than the diminishment object, the color of the object also disappears. Thus, an aspect of determining whether it is appropriate to remove a diminishment object from an environment map will be described as a third modification example.

### Functional Configuration of Information Processing Apparatus

FIG. 22B is a block diagram showing an example of the software configuration (logical configuration) of the information processing apparatus 1 according to the present modification example. A difference from the block diagram in FIG. 13A is that a removal determination unit 22 is added and is also provided with information from the input reception unit 10. The input reception unit 10 according to the present modification example outputs data on a real image to the removal determination unit 22. Further, the feature extraction unit 15 outputs an extracted feature amount to the removal determination unit 22. The removal determination unit 22 then determines whether to remove a diminishment object from an environment map and outputs a determination result to the removal region determination unit 18.

### Operation Flow of Information Processing Apparatus

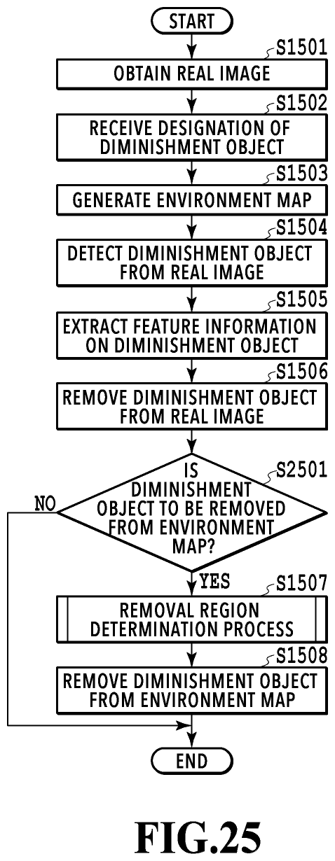

FIG. 25 is a flowchart showing the flow of processing in the information processing apparatus 1. The same step number is given to a step having the same contents as in the flowchart in FIG. 15 described above, and a detailed description thereof will be omitted. Details of the present modification example will be described below with reference to the flowchart in FIG. 25.

In S2501, the removal determination unit 22 determines whether to remove a diminishment object from an environment map. Specifically, the removal determination unit 22 determines whether there is a region having a similar color whose color difference from the RGB value of a region corresponding to the diminishment object (for example, the average RGB value of the region corresponding to the diminishment object extracted in 1505) is less than a threshold value in a region of the real image other than the region corresponding to the diminishment object. In this case, for example, ΔE 20 is used as a threshold. As a result of the determination, in a case where there is no other object with a color similar to the color of the diminishment object in the real image, it is determined that the diminishment object is to be removed, and the process proceeds to the execution of S1507. On the other hand, in a case where there is another object with a color similar to the color of the diminishment object in the real image, it is determined that the diminishment object is not to be removed, and S1507 and S1508 are skipped to end the present flow.

The above is the operation flow of the information processing apparatus 1 according to the present modification example. As a result, optical consistency can be increased by not performing any removal process in a situation where the diminishment object cannot be appropriately removed from the environment map.

As described above, according to the present embodiment including the various modification examples, it is possible to improve the optical consistency of CG in a mixed reality image by appropriately treating an environment map in the case of performing a diminishment process on a real image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to suppress the occurrence of the situation as described above that is not intended by a wearer in an XR technique using an HMD.

This application claims the benefit of Japanese Patent Application No. 2024-109919, filed Jul. 8, 2024 which is hereby incorporated by reference herein in its entirety.

What is claimed is:

1. An information processing apparatus controlling a non-head-mounted first display device and a head-mounted second display device, the information processing apparatus comprising:
one or more memories storing instructions; and
one or more processors executing the instructions to:
obtain stop information on a display on a virtual screen in the second display device; and
determine, in response to the stop information being obtained, a display content on a real screen in the first display device in a case where the display on the virtual screen in the second display device is stopped.

2. The information processing apparatus according to claim 1, wherein the second display device is a device displaying a mixed real image in which the virtual screen is superimposed on an image obtained by capturing real space.

3. The information processing apparatus according to claim 2, wherein in a case where the stop information is obtained, it is determined that a content displayed on the virtual screen is not included in the display content on the real screen in the first display device.

4. The information processing apparatus according to claim 2, wherein
in a case where the stop information is obtained,
a user interface for causing a user to select whether to include, in the display content on the real screen, a content displayed on the virtual screen is displayed on the real screen, and
whether to include, in the display content on the real screen, the content displayed on the virtual screen is determined based on a user input via the user interface.

5. The information processing apparatus according to claim 2, wherein in a case where the stop information is obtained, in a case where it is determined that a content displayed on the virtual screen is not included in the display content on the real screen, the real screen is edited so that the content displayed on the virtual screen cannot be seen.

6. The information processing apparatus according to claim 5, wherein the editing is a process for minimizing, on the real screen, a window displayed on the virtual screen.

7. The information processing apparatus according to claim 5, wherein the editing is a process for hiding a filled form on the real screen of the first display screen out of forms in a window displayed on the virtual screen of the second display screen.

8. The information processing apparatus according to claim 5, wherein the editing is a process for hiding, in the mixed real image, a region displayed on the virtual screen in a window displayed across the real screen of the first display device and the virtual screen of the second display device.

9. An information processing apparatus controlling a head-mounted display device displaying a mixed real image on which a virtual object is superimposed, the information processing apparatus comprising:
one or more memories storing instructions; and
one or more processors executing the instructions to:
remove a specific object from an image obtained by capturing real space for the mixed real image; and
remove the specific object from an environment map used to render the virtual object.

10. The information processing apparatus according to claim 9, wherein the one or more processors execute the instructions to:
generate the environment map from the image obtained by capturing the real space.

11. The information processing apparatus according to claim 10, wherein the one or more processors execute the instructions to:
determine a removal region in which the specific object is reflected in the environment map based on feature information on the specific object in the image obtained by capturing the real space, wherein
the specific object is removed based on the determined removal region.

12. The information processing apparatus according to claim 11, wherein the one or more processors execute the instructions to:
detect a region in which the specific object is reflected from the image obtained by capturing the real space, wherein
the feature information is extracted based on a detection result.

13. The information processing apparatus according to claim 12, wherein the feature information is at least one of an object detection feature amount indicating a type of the detected specific object, an image feature amount indicating color information on the detected specific object, and a three-dimensional feature amount indicating vertex coordinates in a polar coordinate system of a region corresponding to the detected specific object.

14. The information processing apparatus according to claim 13, wherein in a case where the determination is performed based on two or more feature amounts of the object detection feature amount, the image feature amount, and the three-dimensional feature amount, a region obtained by taking a logical product and/or logical sum of a region obtained for each feature amount is determined to be the removal region.

15. The information processing apparatus according to claim 14, wherein the one or more processors execute the instructions to:
extrapolate, for the environment map of a range corresponding to an angle of view of a camera having an angle of view of less than 360 degrees, a range outside the angle of view by complementation using machine learning, wherein
the extrapolation is performed on an environment map after the specific object has been removed.

16. The information processing apparatus according to claim 14, wherein the one or more processors execute the instructions to:
update, for the generated environment map, a range reflected in an image obtained with a camera capturing the real space, wherein
the removal region is determined based on orientation information on the camera at a time of capturing an image in a case where the update is performed and the three-dimensional feature amount.

17. The information processing apparatus according to claim 9, wherein the one or more processors execute the instructions to:
determine whether to remove the specific object from the environment map, wherein
in accordance with a determination result, the specific object is removed from the environment map.

18. The information processing apparatus according to claim 17, wherein in a case where an object of a color whose color difference from the specific object is less than a threshold is reflected in the image obtained by capturing the real space, it is determined that the specific object is not to be removed from the environment map.

19. The information processing apparatus according to claim 18, wherein the threshold is ΔE 20.

20. A method for controlling an information processing apparatus controlling a non-head-mounted first display device and a head-mounted second display device, the method comprising the steps of:
obtaining stop information on a display on a virtual screen in the second display device; and
determining, in response to the stop information being obtained, a display content on a real screen in the first display device in a case where the display on the virtual screen in the second display device is stopped.

21. A method for controlling an information processing apparatus controlling a head-mounted display device displaying a mixed real image on which a virtual object is superimposed, the method comprising the steps of:
removing a specific object from an image obtained by capturing real space for the mixed real image; and
removing the specific object from an environment map used to render the virtual object.

22. A non-transitory computer readable storage medium storing a program for causing a computer to perform a method for controlling an information processing apparatus controlling a non-head-mounted first display device and a head-mounted second display device, the method comprising the steps of:
obtaining stop information on a display on a virtual screen in the second display device; and
determining, in response to the stop information being obtained, a display content on a real screen in the first display device in a case where the display on the virtual screen in the second display device is stopped.

23. A non-transitory computer readable storage medium storing a program for causing a computer to perform a method for controlling an information processing apparatus controlling a head-mounted display device displaying a mixed real image on which a virtual object is superimposed, the method comprising the steps of:
removing a specific object from an image obtained by capturing real space for the mixed real image; and
removing the specific object from an environment map used to render the virtual object.
